(19) United States
(12) Patent Application Publication
(10) Pub. No.: US 2024/0149149 A1
(43) Pub. Date: May 9, 2024

(54) Mobile Handheld Gaming Controller

(71) Applicant: UDU ApS, Frederiksberg C (DK)

(72) Inventors: Asbjørn Høj Christensen, Frederiksberg C (DK); Marius Helmer Larsen, Frederiksberg C (DK)

(21) Appl. No.: 18/550,703

(22) PCT Filed: Mar. 15, 2022
(86) PCT No.: PCT/EP2022/056662

§ 371 Date: Sep. 15, 2023

(30) Foreign Application Priority Data
Mar. 16, 2021 (EP) 21162884

(51) Int. Cl. A63F 13/24; A63F 13/211; A63F 13/235; A63F 13/26

(52) U.S. Cl. CPC A63F 13/24; A63F 13/211; A63F 13/235; A63F 13/26

(57) ABSTRACT

The present invention relates to a mobile handheld gaming controller for active outdoor games having a handle-like 3-dimensional shape suitable for gripping by a human hand, said gaming controller being connectable to at least one mobile communication device, where the gaming controller includes a housing enclosing electronic circuitry including (i) a circuit board, (ii) a power supply optionally mounted on the circuit board, (iii) a motion sensor optionally mounted on the circuit board, (iv) a data processing unit optionally mounted on the circuit board, (v) a data storage unit optionally mounted on the circuit board, (vi) a wireless communication unit optionally mounted on the circuit board, and (vi) a haptic signal generator, characterized in that and the gaming controller further includes a display unit having a visible area of less than 1000 mm² and connects wirelessly with the mobile communication device.

### CROSS REFERENCE TO RELATED APPLICATIONS

This application is a U.S. national phase of International Application No. PCT/EP2022/056662, filed Mar. 15, 2022, which claims priority to European Application No. 21162884, filed Mar. 16, 2021, both of which are incorporated by reference herein in their entirety.

### FIELD OF THE DISCLOSURE

The present invention relates to a mobile handheld gaming controller for active outdoor games providing instructions and/or feed back to a gamer and/or between multiple gamers when executing a game.

### BACKGROUND

Handheld controllers for controlling TV games are known in the art. For example, US2007/0066394 (Nintendo) describes a handheld controller with control buttons, motions detector and haptic signal generator, which during a game interacts with a stationary game console staticly linked to the domestic powergrid and connected to a monitor, typically a TV screen. Modern smart devices such as smartphones, smart watched or tablets could, given appropriate software, also be a handheld gaming controller as most contain.

However, prior art handheld gaming controllers are not mobile nor suited for physically active all-weather outdoor games, such as role-playing games and are too fragile and/or contain too sensitive excess electronics for this purpose and therefore a need is identified for providing improved gaming controllers for this purpose. In US2018/314406 A1 an indoor handheld totem functioning with an external display is shown.

### SUMMARY

The gaming controller of the present invention offers the improvement, advantages and/or advancements over the background art in that it can be used for active outdoors games, such as role-playing games, with any number of gamers which can be separated by long distances—even in separate countries or continents. The gaming controller is ergonomical and allows for a tight grip by human hand(s) and it is sturdy and robust to wear and tear as it is shock resistant, dirt and water resistant and free of excess sensitive electronic circuitry which can break down during operation and consumes unnecessary power. Further, due to the physical separation of the gaming controller of the invention from its mobile communication device counterpart games can be execute solely through a gamer's interactions and reactions to the gaming controller's position, control units, display, light and haptic signals allowing for an intense gaming experience and for a strong sensory focus on the gaming environment, such as the physical surroundings.

Accordingly, in a first aspect the invention provides a mobile handheld gaming controller for active outdoors games having a handle-like 3-dimensional shape suitable for gripping by a human hand, said gaming controller being connectable to at least one mobile communication device, wherein the gaming controller comprises a housing enclosing electronic circuitry comprising (i) a circuit board, (ii) a power supply optionally mounted on the circuit board, (iii) a motion sensor optionally mounted on the circuit board, (iv) a data processing unit optionally mounted on the circuit board, (v) a data storage unit optionally mounted on the circuit board, (vi) a wireless communication unit optionally mounted on the circuit board, and (vi) a haptic signal generator, characterized in that and the gaming controller further comprises a display unit having a visible area of less than 1000 mm2 and connects wirelessly with the mobile communication device.

In a further aspect, the invention provides a gaming assembly for active outdoors games comprising the gaming controller of the invention and a mobile communication device, wherein the gaming controller and the mobile communication device are separate entities in proximity of less than 100 meters; and wherein the mobile communication device is capable of receiving, processing and transmitting data to and from the gaming controller and to receiving and transmitting data to additional data processing devices via long range WiFi or cellular network and/or mobile network; and wherein optionally the mobile communication device is a smartphone, tablet computer, or smart watch.

In a still further aspect, the invention provides a computer-implemented method of providing sensory signals to a human gamer comprising:
providing one or more gaming assemblies of the invention;
providing a movement or change of orientation or actuation of a control unit of the gaming controller generating a first set of data in the motion sensor;
transmitting the first set of data to the data processing unit in the gaming controller and processing said data into a second set of data under the control of a first game software running on the gaming controller;
transmitting the second set of data from the data processing unit in the gaming controller wirelessly to the mobile communication device and processing the second set of data in the mobile communication device to generate a third set of data under the control of a second game software running on the mobile communication device;
and comprising one or more of the following processes:
transmitting the third set of data from the mobile communication device, optionally via the data processing unit and/or the data storage unit, back to the display, the light source and/or haptic signal generator in the gaming controller to produce a sensory impulse; and/or
transmitting the third set of data from the mobile communication device wirelessly to a server unit and processing said data into a fourth set of data under the control of a game software running on the server and transmitting the fourth data set to further gaming assemblies, optionally triggering further data transmissions between the gaming controllers and mobile communication devices of the further gaming assemblies and producing sensory impulses in the displays, the light sources and/or haptic signal generators in the further gaming controllers.

In a still further aspect, the invention provides a gaming software running on the gaming controller and/or the mobile communication device in the gaming assembly of the invention or the server of the invention producing a data signal which generates a sensory impulse/signal in the display, the light source and/or the haptic impulse/signal generator in the gaming controller.

### BRIEF DESCRIPTION OF THE DRAWINGS

The features and advantages of the present invention is readily apparent to those skilled in the art by the below detailed description of embodiments and examples of the invention with reference to the figures and drawings included herein where:

FIG. 1 schematically illustrates a working example of an outer design of a gaming controller 1 of the invention.

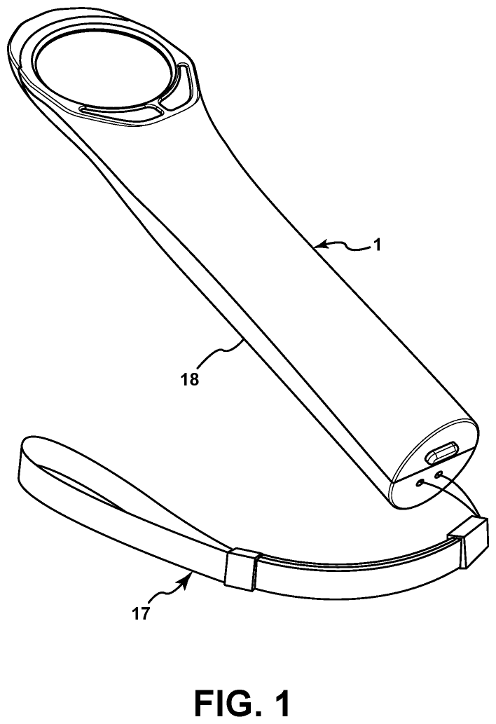

FIG. 2 schematically illustrates a working example of inner and outer components of the gaming controller 1 of the invention.

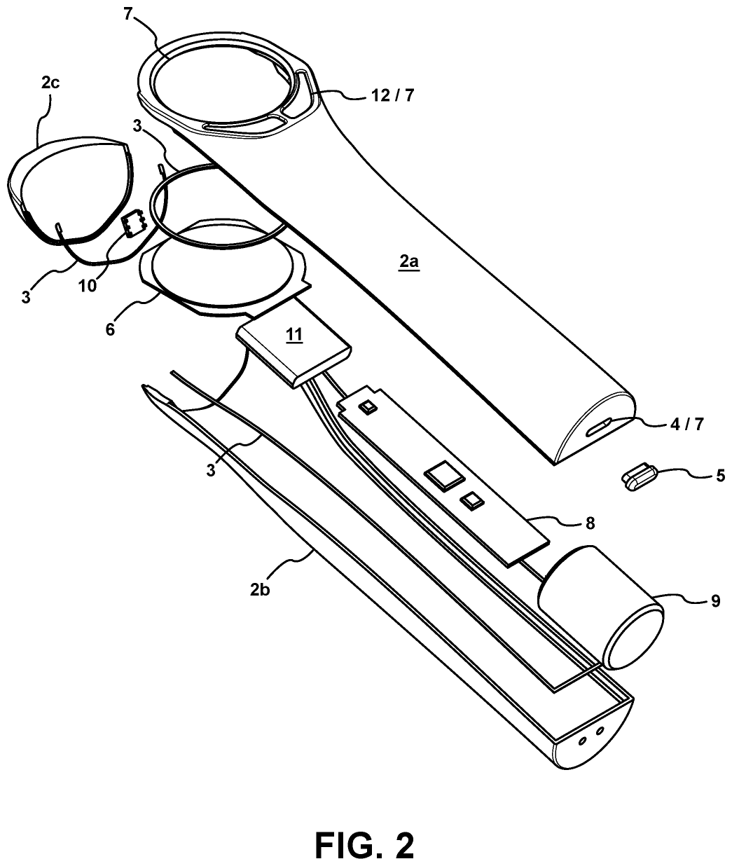

FIG. 3 schematically illustrates a working example of a gaming assembly of the invention comprising the gaming controller 1 and the mobile communication device 13.

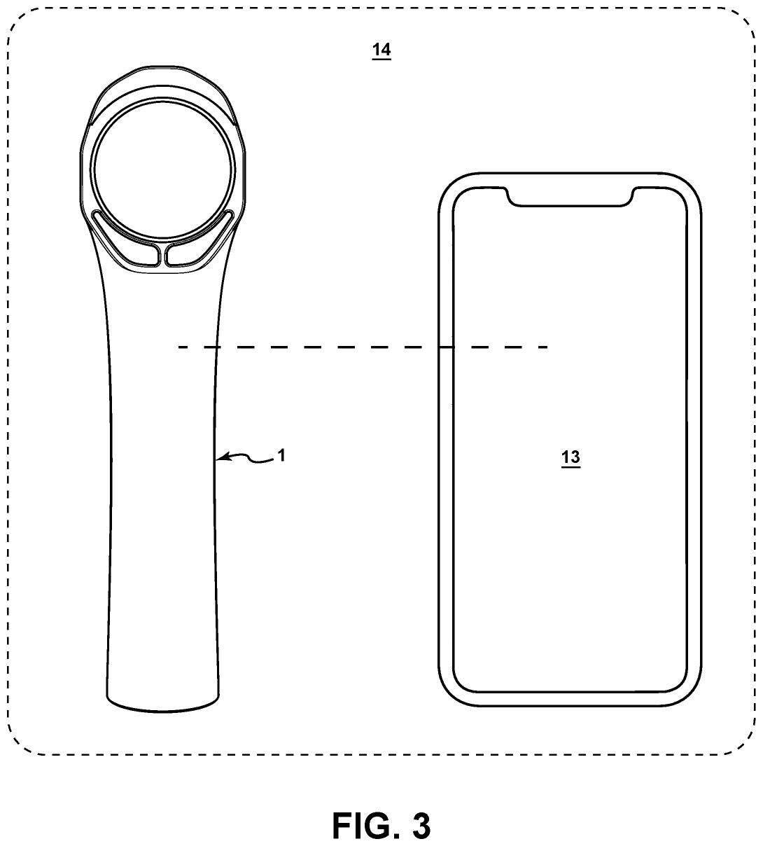

FIG. 4 schematically illustrates a working example of the setup of multiple gaming assemblies 14 interconnected by a game server 15 to execute the software of the invention and the computer implemented method of the invention, allowing for signal transmissions 16A-L and transaction between the gaming controllers 1 and for generation of sensory impulses/signals in the gaming controllers 1 under the control of gaming software running on the gaming controllers 1, the mobile communication devices 13 or the game server 15.

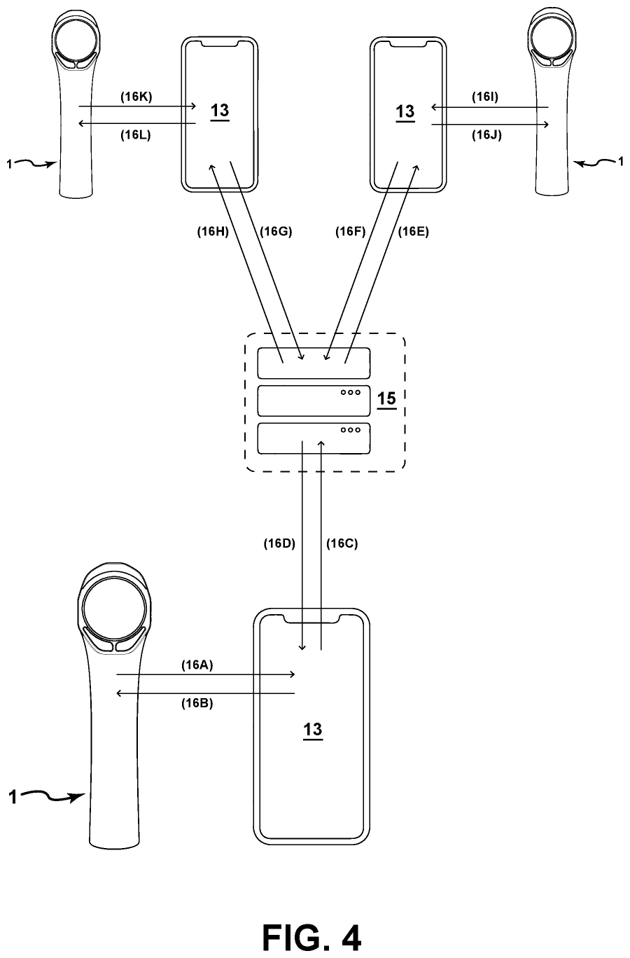

FIG. 5 schematically illustrates another working example of an outer design of a gaming controller 1 of the invention.

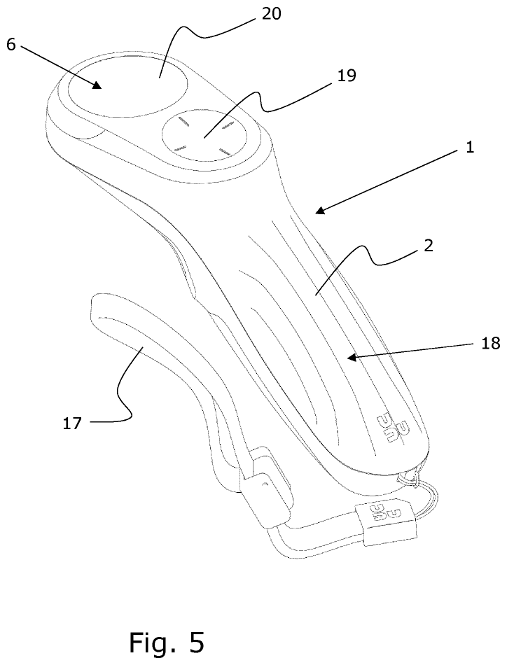

FIG. 6 schematically illustrates in an exploded view the another working example of the gaming controller 1 of FIG. 5. The exploded view illustrates the different components of the gaming controller 1.

All publications, patents, and patent applications that may be referred to herein are incorporated by reference to the same extent as if each individual publication, patent, or patent application was specifically and individually indicated to be incorporated by reference. In the event of a conflict between a term herein and a term in an incorporated reference, the term herein prevails and controls.

### DETAILED DESCRIPTION

The figures included herein are illustrative and simplified for clarity, and they merely show details which are essential to the understanding of the invention, while other details may have been left out. Throughout the specification, claims and drawings the same reference numerals are used for identical or corresponding parts. It is to be noted that the wording “first” and “second” are used for separating elements of similar function. Thus, a “second” element does not necessarily require the presence of a “first” element.

In the first aspect the invention provides a mobile handheld gaming controller 1 for active outdoors games having a handle-like 3-dimensional shape suitable for gripping by a human hand, said gaming controller being connectable to at least one mobile communication device 13, wherein the gaming controller 1 comprises a housing 2 enclosing electronic circuitry, comprising (i) a circuit board, (ii) a power supply 11 optionally mounted on the circuit board, (iii) a motion sensor 28 optionally mounted on the circuit board, (iv) a data processing unit 29 optionally mounted on the circuit board, (v) a data storage unit optionally mounted on the circuit board, (vi) a wireless communication unit 27 optionally mounted on the circuit board, and (vi) a haptic signal generator 9, characterized in that and the gaming controller 1 further comprises a display unit 6 having a visible area of less than 1000 mm2 and connects wirelessly with the mobile communication device 13.

While the gaming controller 1 in use is connected to mobile communication device 13, such as a smartphone, the gaming controller 1 of the invention allows gamers to engage in a game without looking or touching the mobile communication device 13, which can be tucked away in a dry safe place such as a pocket or bag. The gaming controller 1 according to the present invention is configured to provide a gamer with a full gaming experience with the gaming controller 1 as such without the need for actively operating any other devices such as additional external displays, mobile phones or the like. In fact, it is the aim of the present invention to provide a gaming controller 1 for active outdoors games wherein the gamer's gaming experience is provided by the gaming controller as such.

The display unit 6 may have a visible area of less than 1000 mm2. Hereby, the gamer has the possibility of being guided and/or receiving information via the display unit 6 in an easy manner. By having a display unit 6 with a visible area of less than 1000 mm2 it is possible for optimize the size of the gaming controller 1 so that it may be handled/used by persons of different sizes and hand grips, for instance both adults and children. The weight balance of the gaming controller 1 is also important for providing a gaming controller 1 which is usable without having to use to much strength to grip and moving the gaming controller 1 during the active outdoor games. Still further a with a visible area of less than 1000 mm2, is sufficiently small to not get engangle with clothes or other gaming gear that a gamer may wear, which is particularly important for very physical games. However, the visible area of the display unit 6 may not be too small so that it is avoided that the overview of the display 6 not is compromised. In addition, a smaller display 6 is less power consuming than a larger display whereby the gaming controller 1 may be used for a longer time without the power supply has to be recharged. Hence, the size of the display 6 is optimized between size, weight, visible area to provide information and guidance during the game and power consumption.

The gaming controller 1 preferably further comprises one or more control units 12, a light source 10, a connector for charging the power supply and/or a strap 17 for attaching the gaming controller to the wrist of a gamer.

The housing 2 preferably has a symmetrical 3-dimensional shape providing for equal grip by both right and left hand. In one embodiment the housing 2 comprise an upper control surface and a lower surface, wherein the lower surface being curved, the digits of a gamer, in use, curls around the curved lower surface to allow the gamer to firmly grasp and hold the housing 2 and control the orientation thereof, in use, the gamer's thumb digit extending in a suspended manner over the upper control surface, the housings curved lower surface optionally defining a depression therein positioned and dimensioned so as to accept a gamers digit, optionally the gamers trigger finger; wherein the upper control surface comprise the display unit 6 and wherein the motion sensor is configured to sense, at least in part, its own orientation. In further embodiments at least one control unit 12 is disposed on the upper control surface of the housing 2, enabling a gamer's thumb, in use, to be suspended at least in part over and able to descend down onto the control unit 12 so as to actuate and operate said control unit 12 while the gamer maintains a grip on the housing 2. In an additional embodiment at least one control unit 12 is disposed at least in part within said housing curved lower surface depression, enabling a gamer, in use, to selectively actuate said control unit with a digit, optionally the gamers trigger finger. In an attractive embodiment the housing is shaped so that the gaming controller can be operated simultaneously by two hands. The term “digit” as used herein refers to any fingers or part of a finger of the gamer.

The housing 2 may comprise one or more shell elements 2a, 2b, 2c, comprising one or more apertures 7 fitted for mounting the display and optionally the control units 12, said shell elements fitted together to form a container containing the electronic circuitry. More specifically the housing 2 may comprise a first upper shell element 2a, a second lower shell element 2b fitted to tightly connect with the upper shell element 2a, and optionally a third lateral shell element 2c fitted to tightly connect with the upper shell 2a and optionally the lower shell 2b and wherein, optionally one shell comprises an outer depression or aperture 4 for containing i) the connector for charging the power supply or ii) a replaceable power supply both i) and ii) covered by a detachable lid 5. In the embodiment wherein a detachable lid is arranged the lid is sealed off.

The housing 2 of the invention is a container containing electronic circuitry of the gaming controller 1 and as such the housing 2 is preferably resistant to penetration of water and dirt, optionally water and dirt proof. The housing 2 may be fitted with one or more sealing elements 3 in between connections of shells 2a, 2b, 2c and/or apertures 7 connecting the inside of the housing to the outside of the housing. Such sealing element may be a gasket or other suitable means, made from an elastic synthetic or natural polymeric material resistant to water and dirt penetration. Furthermore, the shells of the housing may also be glued or welded together. The gaming controller may be configured to at least fulfill the requirement of Ingress Protection ratings as defined in international standard EN 60529 (European IEC 60509:1989) of IP54, preferably the gaming controller has a higher Ingress Protection rating.

The housing 2 is suitably made from a material comprising a synthetic or natural polymers, metal alloys or a composite thereof. Synthetic polymers include but are not limited to thermoplastic, and/or a thermosetting plastic material, such as thermoplastic elastomers. Natural polymers include wood. Suitable metal alloys include aluminium and/or steel alloys.

In some embodiments the upper shell 2a can be made of a transparent material. In other embodiments at least one shell has an orange signal color, enabling improved visual detection should the controller be dropped or lost during a game.

The housing 2 may preferably comprise a gripping portion 18 having an outer diameter/diagonal of between 2 cm to 10 cm, such as between 2 to 7 cm, such as 2 to 5 cm and an outer length between 10 to 30 cm, such as between 13 cm to 25 cmm such as between 13 to 20 cm. These dimensions provide good gripping properties as well as a good balance of the controller 1. The inner diameter/diagonal of the housing 2 is suitably between below 2 cm to below 10 cm, such as between below 2 to below 7 cm, such as below 2 to below 5 cm and an inner length of between below 10 to below 30 cm, such as between below 13 cm to below 25 cm such as between below 13 to below 20 cm. The gaming controller 1 may have an outer diameter/diagonal of between 1 cm to 10 cm, such as between 1.5 cm to 8 cm, such as between 2 cm and 5 cm, and an outer length of between 10 cm and 35 cm, such as between 10 cm and 20 cm.

The circuit board 8 of the invention is preferably a printed circuit board (PCB) of commercial grade.

The power supply 11 of the invention is suitably a fixed rechargeable battery, such as a Li-ion battery or LiPo battery or Nickel-Cadmium battery or Nickel Metal Hydride or a replaceable battery, such as an AA size or AAA size battery.

The data processing unit 29, CPU, is suitably a microprocessor or a microcontroller or an embedded processor or a Digital Signal Processor or a Media Processor or similar processor. Furthermore, the data processing unit 29 may be employed with a graphics buffer unit. The graphics buffer may be a chip/circuit which stores graphics data to be played back on the display 6. When a particular graphics is to be displayed, a data processing unit on the mobile communication device 13 sends data code to the gaming controller 1, instructing which graphics to retrieve from the graphics buffer and display.

The data storage unit in the gaming controller of the invention, can be any suitable commercially available data storage unit, such as an embedded MultiMediaCard (eMMC) or a Random Access Memory chip (RAM) or an On Chip Memory (RAM).

The wireless communication unit 27 in the gaming controller of the invention suitably comprise a Bluetooth or radio wave transmitter and receiver or a combination thereof. In one embodiment the wireless communication unit 27 is a Bluetooth Low Energy (BLE) radio transmitter and receiver. The wireless communication unit 27 may also comprise a Near Field Communication module.

The display 6 in the gaming controller of the invention can in some embodiments have a visible area of up to 10000 mm², such as up to 7500 mm², such as up to 5000 mm², such as up to 2500 mm², such as up to 1000 mm², such as up to 700 mm², such as between 500 mm² to 1000 mm². The display may preferably be rectangular, circular or ellipsoid or a combination thereof. In some embodiments the display is rectangular and has a dimension between 10-100 mm×10-100 mm, such as between 10-75 mm×10-75 mm, such as 10-50×10-50 mm, such as 15-40×15-40 mm, such 20-30 mm×20-30 mm. In some embodiments the display is circular or ellipsoid and has a longest diameter of between 10-100 mm, such as between 10-75 mm, such as between 10-50 mm, such as between 15-40 mm such as between 20-30 mm. The display 6 of the invention is preferably a LCD/TFT, LED or OLED display, in some embodiments a touch sensitive display and in other embodiments not a touch sensitive display. The latter is particularly relevant for games where unintended or accidental pressures of the display 6 may occur.

The motion sensor 28 of the invention is suitably an Inertia Measuring Unit (IMU) comprising one or more accelerometers, gyroscopes and/or magnetometers 30. In a particular embodiment the motion sensor 28 comprises an accelerometer, a gyroscope and a magnetometer 30, separately or together and optionally on one chip. The accelerometer may suitably be a 3-axis accelerometer, while the gyroscope may be a 3-axis gyroscope and the the magnetometer 30 may be a 3-axis magnetometer. In some embodiment that gaming controller 1 of the invention may also contains a barometer unit, which can inter alia, may provide data about the gaming controller's vertical orientation or movements.

The haptic impulse/signal generator 9 of the invention is suitably a vibration generator, optionally selected from voice coil actuators, eccentric rotating mass actuators, linear resonance actuators, surface transducer actuators, solenoid actuators and/or accelerated ram actuators. In this context haptic may also include cutaneous sensing, such as hot or cold temperatures. Furthermore, the haptic signal generator 9, the display 6 and/or the light source 10 may be configured to receive signals from the motion sensor 28, for instance the IMU. The signals may be provided directly or via a data processing unit, either in the gaming controller and/or the mobile communication device. The haptic signal generator 9, display 6 and/or the light source 10 are then operatively connected with the motion sensor 28 so that when the motion sensor 28 detects or senses a motion of the gaming controller 1 it transmits the detected or sensed data or signals to the haptic signal generator, display and/or the light source 10 either directly or via a data processing unit, whereby the gamer may sense the reaction of the detected motion and be guided by the display 6 and/or light source 10. The gaming controller 1 thereby provide a full gaming experience to the gamer without the use of other external displays. The haptic signal generator 9 may be arranged opposite the curved lower surface so that the gamer will experience the haptic signal at the area of the gaming controller wherein he/she is gripping around it.

In addition, the haptic signal generator 9 may be arranged at a predetermined distance from the circuit board 8 and/or IMU 28 and/or magnetometer 30. Furthermore, the haptic signal generator 9 may shielded off from the circuit board 8 and/or the IMU 28 and/or magnetometer 30 for minimizing magnetic field or other interference between them.

The control units 12 may suitably comprise single touch buttons, multiple buttons, multiple touch buttons, capacitive touch buttons, full-hand squeeze buttons, joystick buttons, depressible buttons and/or track pad(s) 19. In some embodiments the depressible button comprises a cross switch, a push button or a wedge shaped spring loaded button. The surface of the one or more control units 12 are preferable made in a material which provides good traction, in use, between the button material and the skin of a gamer. Such materials include elastic natural or synthetic polymers. Also, the one or more control units 12 may be sealed off.

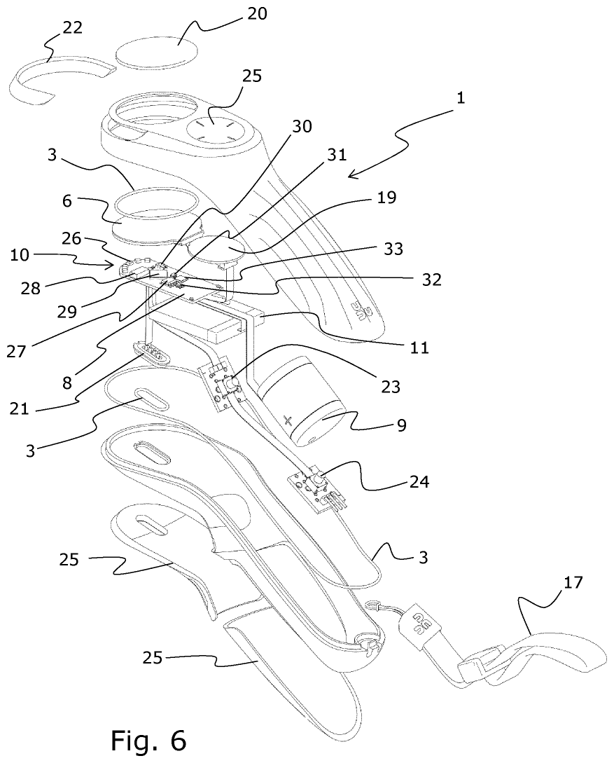

In FIG. 6 an embodiment of the gaming controller 1 of the invention is shown in expoded view. In the present embodiment the gaming controller 1 comprises several control units 12, here in the form of a track pad 19, a trigger button 23 and a squeeze button 24. Each control unit 12 is covered by a cover button pad 25 which ensure that the gamer may activate the control units 12 and further ensure that the control units and/or buttons are protected and sealed off. The cover button pads 25 may be made of any suitable material, such as for instance silicone. It is expedient if the cover button pads 25 are made of a material which may enhance the grip of the gamer around the gaming controller 1. The gaming controller 1 further comprises a display cover 20 and a LED cover 22. Both the display cover 20 and LED cover 22 may be made of a transparent material. In addition, the housing/covers encapsulate and protects the different components of the gaming controller 1. In the present embodiment the following components are connected with the circuit board 8, a plurality of LEDs 26 of the light source 10, a communication unit 27, the motion sensor or IMU 28, a data processing unit or MCU 29, a magnetometer 30, a LED driver 31, a track pad driver 32 and haptic signal generator driver 33. In other embodiments additional components may optionally be connected with the circuit board 8, however, fewer components may as well be present. A power supply 11 is also arranged inside the gaming controller 1. Furthermore, the present embodiment has magnetic port connector 21 for enabling charging of the power supply 11 and/or data transfer through the magnetic port connector 21. The haptic signal generator 9 is in the present embodiment arranged at a distance from the circuit board 8. For enhancing the water and dirt resistance of the gaming controller 1 all exterior parts of the gaming controller, i.e. housing and cover parts are sealed off via sealing elements 3.

The light source 10 suitably emits visible light outside of the housing (1), and said light source 10 can be a LED or a RGB LED capable of emitting multiple colors of visible light. The light source 10 and/or the display 6 may be configured to guide the gamer during the active outdoor game. The light source 10 may be one light source or may be a plurality of light sources. Also, a light source 10 may comprise a plurality of LEDs 26 and/or RGB LEDs or a combination thereof.

The strap 17 of the invention is suitably a wrist strap made from woven or braided flexible synthetic of natural fibers and optionally comprises a buckle for lengths adjustment and/or a mechanism that allows for attachment/detachment of the strap from the gaming controller 1.

The connector for charging the power supply 11 is suitably a USB-C, Micro-USB port, an inductive charging connector or a magnetic port connector 21. Additionally, the magnetic port connector 21 may be a two-way two or more pin magnetic port, such as a four-pin magnetic port for enabling charging of the power supply and/or data transfer through the magnetic port connector. The magnetic port connector 21 may comprise a plurality of pin magnetic ports, such as for instance, four, five or even more.

The gaming controller 1 of the invention is for increased robustness and stability in use free of excess sensitive electronic circuitry which can break down during operation and consumes unnecessary power. Accordingly, in a special embodiment the electronic circuitry of the gaming controller 1 of the invention does not contain speakers, SIM card ports, cameras, GPS transmitters or wireless transmitters/receivers for long distance communications, such as via cellular networks and/or mobile networks. In some embodiments the display 6 of the gaming controller 1 is not a pressure sensitive (touch) display. In an embodiment, the display 6 is protected by a transparent or semitransparent display cover 20 so that damage to the display 6 is minimized if the gaming controller 1 is dropped on the ground or hits a hard obstacle during the active use of the gaming controller 1. The display cover 20 may be made of a material which is such as polycarbonate or similar materials.

In a separate aspect, the invention also provides a gaming assembly 14 comprising the gaming controller 1 and the mobile communication device 13 of the invention, wherein the gaming controller 1 and the mobile communication device 13 are separate entities in proximity of less than 100 meters which is the maximal distance for most current Bluetooth communication units, such as less than 75 meters, such as less than 50 meter,m such as less than 25 meters, such as less than 10 meters, such as 5 meters or less. The mobile communication device 13 is capable of receiving, processing and transmitting data to and from the gaming controller and of receiving, processing and transmitting data to an additional data processing device, such as a game server 15 via long distance communications such as WiFi or cellular networks and/or mobile networks. The mobile communication device 13 is preferably a smartphone, a laptop, a tablet computer or a smart watch.

In a further separate aspect, the invention also provides a computer-implemented method of providing sensory impulses/signals to a human gamer. In the context of this invention sensory is to be understood as visual, haptic or cutaneous impulses/signals. The method comprises the steps of:
a) providing one or more gaming assemblies 14 as mentioned above;
b) providing a movement or change of orientation or actuation of a control unit 12 of the gaming controller 1 generating a first set of data in the motion sensor;
c) transmitting the first set of data to the data processing unit in the gaming controller 1 and processing said data into a second set of data 16A under the control of a first game software running on the gaming controller 1;
d) transmitting the second set of data 16A from the data processing unit in the gaming controller 1 wirelessly to the mobile communication device 13 and processing the second set of data 16A in the mobile communication device 13 to generate a third set of data under the control of a second game software running on the mobile communication device 13;
and further comprises one or more of the further steps:
e) transmitting the third set of data 16B from the mobile communication device 13, optionally via the data processing unit and/or the data storage unit, back to the display 6, the light source 10 and/or haptic signal generator 9 in the gaming controller 1 to produce a sensory impulse; and/or
f) transmitting the third set of data 16C from the mobile communication device 13 wirelessly to a server unit 15 and processing said data into a fourth set of data under the control of a game software running on the server and transmitting the fourth data 16 E-H set to further gaming assemblies, optionally triggering further data transmissions 16 I-L between the gaming controllers 1 and mobile communication devices 13 of the further gaming assemblies and producing sensory impulses in the displays 6, the light sources 10 and/or haptic signal generators 9 in the further gaming controllers 1.

The first, second and third program codes (game softwares) may be the same or different.

In a further separate aspect, the invention also provides a computer program (gaming software) running on the gaming controller 1, the mobile communication device 13 and/or the server 15 of the invention producing a data signal which generates a sensory impulse/signal in the display 6, the light source 10 and/or the haptic impulse/signal generator 9 in the gaming controller 1.

### REFERENCES

1 Gaming controller
2 Housing and housing shells
3 Sealing/gasket
4 Aperture or depression for external battery charge connector or for replaceable batteries
5 Lid
6 Display
7 Aperture(s) for display and control units
8 Circuit board
9 Haptic impulse/signal generator
10 Light source
11 Power supply
12 Control unit(s)
13 Mobile communication device
14 Gaming assembly
15 Gaming server
16 Wireless data transmissions
17 Strap
18 Gripping portion
19 Track pad
20 Display cover
21 Magnetic port connector
22 LED cover
23 Trigger button
24 Squeeze button
25 Cover button pad
26 LED
27 Communication unit
28 Motion sensor, IMU
29 Data processing unit, MCU
30 Magnetometer
31 LED driver
32 Track pad driver
33 Haptic signal generator driver

Items of the Invention

1. A mobile handheld gaming controller (1) for active outdoors games having a handle-like 3-dimensional shape suitable for gripping by a human hand, said gaming controller being connectable to at least one mobile communication device (13), wherein the gaming controller (1) comprises a housing (2) enclosing electronic circuitry comprising (i) a circuit board (8), (ii) a power supply (11) optionally mounted on the circuit board, (iii) a motion sensor optionally mounted on the circuit board, (iv) a data processing unit optionally mounted on the circuit board, (v) a data storage unit optionally mounted on the circuit board, (vi) a wireless communication unit optionally mounted on the circuit board, and (vi) a haptic signal generator (9), characterized in that and the gaming controller (1) further comprises a display unit (6) having a visible area of less than 1000 mm2 and connects wirelessly with the mobile communication device (13).

2. The gaming controller of item 1, further being operatively connected with the mobile communication device and being configured to provide a full gaming experience for a gamer independently of other external displays.

3. The gaming controller of item 1 or 2, further comprising one or more control units (12).

4. The gaming controller of any preceding item, further comprising a light source (10).

5. The gaming controller of any preceding item, further comprising a strap (17) for attaching the gaming controller to the hand of a gamer.

6. The gaming controller of any preceding item, further comprising a connector for charging the power supply.

7. The gaming controller of any preceding item, wherein the housing (2) has a symmetrical 3-dimensional shape providing for equal grip by both right and left hand.

8. The gaming controller of any preceding item, wherein the housing (2) comprises an upper control surface and a lower surface, wherein the lower surface being curved, in use the digits of a gamer curls around the curved lower surface to allow the gamer to firmly grasp and hold the housing (2) and control the orientation thereof, in use, the gamer's thumb digit extending in a suspended manner over the upper control surface, the housing curved lower surface optionally defining a depression therein positioned and dimensioned so as to accept a gamer digit, optionally the gamers trigger finger; wherein the upper control surface comprise the display unit (6) and wherein the motion sensor is configured to sense, at least in part, its own orientation.

9. The gaming controller of item 3, wherein at least one control unit (12) is disposed on the upper control surface, enabling a gamer's thumb, in use, to be suspended at least in part over and able to descend down onto the control unit (12) so as to actuate and operate said control unit (12) while the gamer maintains a grip on the housing (2).

10. The gaming controller of item 3 or 9, wherein at least one control unit (12) is disposed at least in part within said housing curved lower surface depression, enabling a gamer, in use, to selectively actuate said control unit with a digit, optionally the gamers trigger finger.

11. The gaming controller of any preceding item, wherein the gaming controller can be operated simultaneously by two hands.

12. The gaming controller of any preceding item, wherein the housing (2) comprises one or more shell elements (2a, 2b, 2c), comprising one or more apertures (7) fitted for mounting the display and optionally the control units (12), said shell elements fitted together to form a container containing the electronic circuitry.

13. The gaming controller of item 12, wherein the housing (2) comprises a first upper shell element (2a), a second lower shell element (2b) fitted to tightly connect with the upper shell element (2a), and optionally a third lateral shell element (2c) fitted to tightly connect with the upper shell (2a) and optionally the lower shell (2b) and wherein, optionally one shell comprises an outer depression or aperture (4) for containing i) the connector for charging the power supply or ii) a replaceable power supply both i) and ii) covered by a detachable lid (5).

14. The gaming controller of any preceding item, wherein the housing is resistant to water and dirt and is fitted with one or more sealing elements (3) in between connections of shells (2a, 2b, 2c) and/or apertures (7) connecting the inside of the housing to the outside of the housing.

15. The gaming controller of item 14, wherein the sealing element is a gasket.

16. The gaming controller of items 14 to 15, wherein the housing is water and dust resistant.

17. The gaming controller of items 12 to 16, wherein the shell elements (2a, 2b, 2c) are glued or welded together.

18. The gaming controller of items 12 to 17, wherein all apertures, openings, buttons in the housing are covered and/or sealed off for ensuring that the gaming controller is water and dust proof.

19. The gaming controller of items 12 to 18, further configured to at least fulfill the requirement of Ingress Protection ratings as defined in international standard EN 60529 (European IEC 60509:1989) of IP54, preferably a higher Ingress Protection rating.

20. The gaming controller of any preceding item, wherein the housing (2) is made from a material comprising a synthetic or natural polymer, metal alloy or a composite thereof.

21. The gaming controller of item 20, wherein the synthetic polymer is a thermoplastic, and/or a thermosetting plastic material, such as a thermoplastic elastomer.

22. The gaming controller of item 20, wherein the metal alloy is an aluminium or steel alloy.

23. The gaming controller of item 20, wherein the housing is made from wood.

24. The gaming controller of item 13, wherein the upper shell (2a) is transparent.

25. The gaming controller of item 13, wherein at least one shell has an orange signal color.

26. The gaming controller of any preceding item, wherein the housing (2) has a gripping portion (18) having an outer diameter/diagonal between 2 cm to 5 cm and a length between 13 cm to 20 cm.

27. The gaming controller of any preceding item, wherein the housing (2) has an inner diameter/diagonal between 1 cm to 5 cm and a length between 13 to 19 cm.

28. The gaming controller of any preceding item, wherein the circuit board is a printed circuit board (PCB).

29. The gaming controller of any preceding item, wherein the power supply (11) is a fixed rechargeable battery, such as a Li-ion battery or LiPo battery or Nickel-Cadmium battery or Nickel Metal Hydride or a replaceable battery, such as an AA size or AAA size battery.

30. The gaming controller of any preceding item, wherein the data processing unit, is a microprocessor or a microcontroller or an embedded processor or a Digital Signal Processor or a Media Processor.

31. The gaming controller of any preceding item, wherein the electronic circuitry further comprises a graphics buffer unit.

32. The gaming controller of any preceding item, wherein the data storage unit is an embedded MultiMediaCard (eMMC) or an On Chip Memory (RAM).

33. The gaming controller of any preceding item, wherein the wireless communication unit comprise a Bluetooth or radio wave transmitter and receiver or a combination thereof, optionally a Bluetooth Low Energy (BLE) radio transmitter and receiver.

34. The gaming controller of item 33, wherein the wireless communication unit further comprise a Near Field Communication module.

35. The gaming controller of any preceding item, wherein the visible area of the display is between 500 mm2 to 1000 mm2

36. The gaming controller of item 35, wherein the display is rectangular, circular or ellipsoid or a combination thereof.

37. The gaming controller of item 36, wherein the rectangular display has a dimension between 20-30 mm×20-30 mm.

38. The gaming controller of item 36, wherein the circular or ellipsoid display has a longest diameter of between 15 mm to 30 mm.

39. The gaming controller of items 35 to 38, wherein the display is a LCD/TFT, LED or OLED display.

40. The gaming controller of items 35 to 39, wherein the display is protected by a transparent display cover (20), the display cover may be made of a material such as polycarbonate or similar materials.

41. The gaming controller of item 35 to 40, wherein the display is a pressure sensitive touch display.

42. The gaming controller of any preceding item, wherein the motion sensor is an Inertia Measuring Unit (IMU) comprising one or more accelerometers, gyroscopes and/or magnetometers.

43. The gaming controller of item 42, wherein the IMU comprises an accelerometer, a gyroscope and a magnetometer, separately or together on one chip.

44. The gaming controller of item 42 or 43, wherein the accelerometer is a 3-axis accelerometer.

45. The gaming controller of item 42 or 43, wherein the gyroscope is a 3-axis gyroscope.

46. The gaming controller of item 42 or 43, wherein the magnetometer is a 3-axis magnetometer.

47. The gaming controller of any preceding item, wherein the haptic signal generator is a vibration generator, optionally selected from voice coil actuators, eccentric rotating mass actuators, linear resonance actuators, surface transducer actuators, solenoid actuators and/or accelerated ram actuators.

48. The gaming controller of any of the preceding item, wherein the haptic signal generator (9), the display (6) and/or the light source (10) is configured to receive signals from the motion sensor.

49. The gaming controller of item 3, wherein the one or more control units (12) comprise a single touch button.

50. The gaming controller of item 3, wherein the one or more control units (12) comprise a track pad (19).

51. The gaming controller of item 49 or 50, wherein the one or more control units (12) comprise a multiple button.

52. The gaming controller of item 49 or 50, wherein the one or more control units (12) comprise a capacitive touch button.

53. The gaming controller of item 49 or 50, wherein the one or more control units (12) comprise a full-hand squeeze button.

54. The gaming controller of item 49 or 50, wherein the one or more control units (12) comprise a joystick button.

55. The gaming controller of item 49 or 50, wherein the one or more control units (12) is a depressible button.

56. The gaming controller of item 55, wherein the depressible button comprises a cross switch, a push button or a wedge shaped spring loaded button.

57. The gaming controller of item 49 to 56, wherein the surface of the one or more control units (12) are made from an elastic natural or synthetic polymer.

58. The gaming controller of item 4, wherein the light source (10) emits visible light outside of the housing (1).

59. The gaming controller of item 58, wherein the light source (10) comprises a LED, a RGB LED capable of emitting multiple colors of visible light.

60. The gaming controller of item 5, wherein the strap (17) is a wrist strap made from woven or braided flexible synthetic of natural fibers and optionally comprises a buckle for lengths adjustment and/or a mechanism that allows for attachment/detachment of the strap from the gaming controller.

61. The gaming controller of item 6, wherein the connector for charging the power supply is a USB-C, Micro-USB port, an inductive charging connector or a magnetic port connector (21).

62. The gaming controller of item 61, wherein the magnetic port connector (21) is a two-way two or more pin magnetic port, such as a four-pin magnetic port or a five-pin magnetic port for enabling charging of the power supply and/or data transfer through the magnetic port connector.

63. The gaming controller of any preceding item, wherein electronic circuitry does not contain a speaker, a SIM card port, a camera, a GPS transmitter or a long-range wireless transmitter/receiver for cellular networks and/or mobile networks.

64. A gaming assembly (14) comprising the gaming controller (1) of any preceding items and a mobile communication device (13), wherein the gaming controller (1) and the mobile communication device (13) are separate entities in proximity of less than 100 meters.

65. The gaming assembly of item 64, wherein the mobile communication device (13) is capable of receiving, processing and transmitting data to and from the gaming controller and to receiving and transmitting data to additional data processing devices via long range WiFi or cellular networks and/or mobile networks.

66. The gaming assembly of items 64 or 65, wherein the mobile communication device (13) is a smartphone, laptop, tablet computer or smart watch.

67. The gaming assembly of items 64 to 66, further comprising a server unit (15).

68. A computer-implemented method of providing sensory signals to a human gamer comprising
a) providing one or more gaming assemblies (14) of items 64 to 67;
b) providing a movement or change of orientation or actuation of a control unit (12) of the gaming controller (1) generating a first set of data in the motion sensor;
c) transmitting the first set of data to the data processing unit in the gaming controller (1) and processing said data into a second set of data (16A) under the control of a first game software running on the gaming controller (1);
d) transmitting the second set of data (16A) from the data processing unit in the gaming controller (1) wirelessly to the mobile communication device (13) and processing the second set of data (16A) in the mobile communication device (13) to generate a third set of data under the control of a second game software running on the mobile communication device (13);
and comprising one or more of the following processes:
e) transmitting the third set of data (16B) from the mobile communication device (13), optionally via the data processing unit and/or the data storage unit, back to the display (6), the light source (10) and/or haptic signal generator (9) in the gaming controller (1) to produce a sensory impulse; and/or
f) transmitting the third set of data (16C) from the mobile communication device (13) wirelessly to a server unit (15) and processing said data into a fourth set of data under the control of a game software running on the server and transmitting the fourth data (16 E-H) set to further gaming assemblies, optionally triggering further data transmissions (16 I-L) between the gaming controllers (1) and mobile communication devices (13) of the further gaming assemblies and producing sensory impulses in the displays (6), the light sources (10) and/or haptic signal generators (9) in the further gaming controllers (1).

69. A gaming software running on the gaming controller (1) and/or the mobile communication device (13) in the gaming assembly of items 64 to 67 or the server unit (15) producing a data signal which generates a sensory impulse/signal in the display (6), the light source (10) and/or the haptic impulse/signal generator (9) in the gaming controller (1).

70. A data processing apparatus comprising means for carrying out the method of item 68.

71. The data processing apparatus of item 70, wherein the apparatus is the gaming controller (1) and/or the mobile communication device (13) in the gaming assembly and/or the server (15).

72. Use of a gaming controller (1) of items 1 to 63 for active outdoors games.

1. A mobile handheld gaming controller for active outdoor games, having a handle-like 3-dimensional shape suitable for gripping by a human hand, said gaming controller being connectable to at least one mobile communication device, wherein the gaming controller comprises a housing enclosing electronic circuitry comprising (i) a circuit board, (ii) a power supply optionally mounted on the circuit board, (iii) a motion sensor optionally mounted on the circuit board, (iv) a data processing unit optionally mounted on the circuit board, (v) a data storage unit optionally mounted on the circuit board, (vi) a wireless communication unit optionally mounted on the circuit board, and (vi) a haptic signal generator, characterized in that and the gaming controller further comprises a display unit having a visible area of less than 1000 mm² and connects wirelessly with the mobile communication device.

2. The gaming controller of claim 1, further comprising one or more control units, a light source, a connector for charging the power supply and optionally a strap for attaching the gaming controller to the wrist of a gamer.

3. The gaming controller of claim 1, wherein the housing comprises an upper control surface and a lower surface, wherein the lower surface being curved, in use the digits of a gamer curls around the curved lower surface to allow the gamer to firmly grasp and hold the housing and control the orientation thereof, in use, the gamer's thumb digit extending in a suspended manner over the upper control surface, the housing curved lower surface optionally defining a depression therein positioned and dimensioned so as to accept a gamer digit, optionally the gamers trigger finger; and wherein the upper control surface comprise the display unit and at least one control unit is disposed on the upper control surface, enabling a gamer's thumb, in use, to be suspended at least in part over and able to descend down onto the control unit so as to actuate and operate said control unit while the gamer maintain a grip on the housing; and wherein the motion sensor is configured to sense, at least in part, its own orientation.

4. The gaming controller of claim 1, wherein the housing comprises a first upper shell element, a second lower shell element fitted to tightly connect with the upper shell element, and optionally a third lateral shell element fitted to tightly connect with the upper shell and optionally the lower shell, said shells elements comprising one or more apertures fitted for mounting the display and optionally the control units, said shell elements fitted together with one or more sealing elements in between connections of shells and/or apertures connecting the inside of the housing to the outside of the housing to form a container containing the electronic circuitry resistant to water and dirt.

5. The gaming controller of claim 1, wherein the housing comprises a first upper shell element, a second lower shell element fitted to tightly connect with the upper shell element, and optionally a third lateral shell element fitted to tightly connect with the upper shell and optionally the lower shell, said shells elements comprising one or more apertures fitted for mounting the display and optionally the control units, and wherein the shell elements are glued or welded together.

6. The gaming controller of claim 4, wherein all apertures, openings, buttons in the housing are covered and/or sealed off for ensuring that the gaming controller is water and dust resistant.

7. The gaming controller of claim 1, wherein
a) the circuit board comprises a printed circuit board (PCB);
b) the power supply comprises a fixed rechargeable battery, such as a Li-ion battery or LiPo battery or Nickel-Cadmium battery or Nickel Metal Hydride or a replaceable battery, such as an AA size or AAA size battery;
c) the data processing unit comprises a microprocessor, a microcontroller, an embedded processor, a Digital Signal Processor, a Media Processor and/or a graphics buffer;
d) the data storage unit comprises an embedded MultiMediaCard (eMMC) or a Random Access Memory chip; and
e) the wireless communication unit comprises a Bluetooth, optionally a Bluetooth Low Energy (BLE), radio transmitter and receiver.

8. The gaming controller of claim 1, wherein the display is rectangular, circular or ellipsoid, optionally pressure sensitive, LCD/TFT, LED or OLED display.

9. The gaming controller of claim 1, wherein the motion sensor is an Inertia Measuring Unit (IMU) comprising a 3-axis accelerometer, a 3-axis gyroscope and a 3-axis magnetometer, which optionally each can be in the same or separate integrated circuits or chips.

10. The gaming controller of claim 1, wherein the haptic signal generator is a vibration generator, optionally selected from voice coil actuators, eccentric rotating mass actuators, linear resonance actuators, surface transducer actuators, solenoid actuators and/or accelerated ram actuators.

11. The gaming controller of claim 1, wherein the haptic signal generator is arranged at a predetermined distance from the circuit board and/or IMU and/or magnetometer, and optionally, the haptic signal generator is shielded off from the circuit board and/or the IMU and/or magnetometer for minimizing magnetic field interference between them.

12. The gaming controller of claim 2, wherein the one or more control units comprises one or more of:
a) a single touch button;
b) a multiple button;
c) a capacitive touch button;
d) a full-hand squeeze button;
e) a joystick button; and
f) a depressible button selected from a cross switch button, a push button or a wedge-shaped spring-loaded button.

13. The gaming controller of claim 2, wherein the light source comprises a LED, a RGB LED capable of emitting multiple colors of visible light.

14. The gaming controller of claim 1, wherein electronic circuitry does not contain a speaker, a SIM card port, a camera, a GPS transmitter or a long-range wireless transmitter/receiver for cellular networks and/or mobile networks.

15. The gaming controller of claim 2, wherein the connector for charging the power supply is a USB-C, Micro-USB port, an inductive charging connector or a magnetic port connector.

16. The gaming controller of claim 15, wherein the magnetic port connector is a two-way two or more pin magnetic port, such as a four-pin magnetic port or a five-pin magnetic port for enabling charging of the power supply and/or data transfer through the magnetic port connector.

17. The gaming controller of claim 1, wherein the visible area of the display is between 500 mm² to 1000 mm².

18. A gaming assembly comprising the gaming controller of claim 1 and a mobile communication device, wherein the gaming controller and the mobile communication device are separate entities in proximity of less than 100 meters; and wherein the mobile communication device is capable of receiving, processing and transmitting data to and from the gaming controller and to receiving and transmitting data to additional data processing devices via long range WiFi or cellular networks and/or mobile networks; and wherein optionally the mobile communication device is a smartphone, tablet computer, or smart watch.

19. The gaming assembly of claim 18, further comprising a server unit.

20. A computer-implemented method of providing sensory signals to a human gamer comprising:
a) providing one or more gaming assemblies of claim 18;
b) Providing a movement or change of orientation or actuation of a control unit of the gaming controller generating a first set of data in the motion sensor;
c) transmitting the first set of data to the data processing unit in the gaming controller and processing said data into a second set of data under the control of a first game software running on the gaming controller;
d) transmitting the second set of data from the data processing unit in the gaming controller wirelessly to the mobile communication device and processing the second set of data (4-6A) in the mobile communication device to generate a third set of data under the control of a second game software running on the mobile communication device;
and comprising one or more of the following processes:
e) transmitting the third set of data from the mobile communication device, optionally via the data processing unit and/or the data storage unit, back to the display, the light source and/or haptic signal generator in the gaming controller to produce a sensory impulse; and/or
f) transmitting the third set of data from the mobile communication device wirelessly to a server unit and processing said data into a fourth set of data under the control of a game software running on the server and transmitting the fourth data set to further gaming assemblies, optionally triggering further data transmissions between the gaming controllers and mobile communication devices of the further gaming assemblies and producing sensory impulses in the displays, the light sources and/or haptic signal generators in the further gaming controllers.

21. A gaming software running on the gaming controller and/or the mobile communication device in the gaming assembly of claim 18 or the server producing a data signal which generates a sensory impulse/signal in the display, the light source and/or the haptic impulse/signal generator in the gaming controller.
